(19) United States
(12) Patent Application Publication
(10) Pub. No.: US 2026/0186749 A1
(43) Pub. Date: Jul. 2, 2026

(54) AUTOMATED CODE GENERATION WITH PRE-TRAINED LARGE LANGUAGE MODEL (LLM) ENHANCED BY DYNAMICALLY ESTABLISHED PIPELINES TAILORED FOR CODE ADAPTATIONS

(71) Applicant: International Business Machines Corporation, Armonk, NY (US)

(72) Inventors: Maja Curic, Munich (DE); Alecio Pedro Delazari Binotto, Munich (DE); Sagar Tayal, Ambala City (IN); Dinesh C. Verma, New Castle, NY (US)

(21) Appl. No.: 19/007,684

(22) Filed: Jan. 2, 2025

(51) Int. Cl. G06F 8/30; G06N 5/022

(52) U.S. Cl. CPC G06F 8/30; G06N 5/022

(57) ABSTRACT

A code segment and at least one corresponding code error are obtained. A fine-tuned code large language model is selected based on the code segment. At least one dynamic pipeline is instantiated, the at least one dynamic pipeline comprising the selected fine-tuned code large language model and a code adaptation action recommender. Adapted code is generated, using the instantiated at least one dynamic pipeline, based on the code segment and the at least one corresponding code error and the adapted code is deployed.

### BACKGROUND

The present invention relates generally to the electrical, electronic and computer arts and, more particularly, to computer-aided software development.

Understanding proprietary application programming interfaces (APIs) is a tedious, time-consuming process that requires experienced subject matter experts (SMEs). It typically involves going through known tools that assist the developer in developing, designing and documenting APIs, such as RESTful APIs, determining what parameters to use, understanding how different commands relate, testing the API out, making sense of the responses, and checking if the configuration does what it is supposed to do. While vendors offer documentation with instructions for equipment configuration, the documentation primarily focuses on details about individual commands rather than providing insights into the sequences of commands required to achieve specific goals. Vendors also use proprietary functions; hence, large language models (LLMs) pre-trained for other coding languages cannot be leveraged. Existing LLMs also cannot be fine-tuned since correct examples are often not available.

### BRIEF SUMMARY

Principles of the invention provide systems and techniques for automated code generation with a pre-trained LLM enhanced by dynamically established pipelines tailored for code adaptations. In one aspect, an exemplary method includes the operations of obtaining a code segment and at least one corresponding code error; selecting a fine-tuned code large language model based on the code segment; instantiating at least one dynamic pipeline, the at least one dynamic pipeline comprising the selected fine-tuned code large language model and a code adaptation action recommender; generating, using the instantiated at least one dynamic pipeline, adapted code based on the code segment and the at least one corresponding code error; and deploying the adapted code.

In one aspect, a computer program product comprises one or more tangible computer readable storage media and program instructions stored on at least one of the one or more tangible computer-readable storage media, the program instructions executable by a processor, the program instructions comprising obtaining a code segment and at least one corresponding code error; selecting a fine-tuned code large language model based on the code segment; instantiating at least one dynamic pipeline, the at least one dynamic pipeline comprising the selected fine-tuned code large language model and a code adaptation action recommender; generating, using the instantiated at least one dynamic pipeline, adapted code based on the code segment and the at least one corresponding code error; and deploying the adapted code.

In one aspect, an apparatus comprises a memory and at least one processor, coupled to the memory, and operative to perform operations comprising obtaining a code segment and at least one corresponding code error; selecting a fine-tuned code large language model based on the code segment; instantiating at least one dynamic pipeline, the at least one dynamic pipeline comprising the selected fine-tuned code large language model and a code adaptation action recommender; generating, using the instantiated at least one dynamic pipeline, adapted code based on the code segment and the at least one corresponding code error; and deploying the adapted code.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action other than by performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is an example workflow for generating vendor-specific software;

FIG. 2 is a block diagram of an example system for automated code generation using pre-trained LLMs enhanced by dynamically established pipelines, in accordance with example embodiments;

FIG. 3 is a table of example information generated during multiple iterations of code adaptation, in accordance with example embodiments;

FIG. 4 is a table of example information maintained by the code adaptation knowledge base 276, in accordance with example embodiments; and

FIG. 5 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that in one aspect, an exemplary method includes the operations of obtaining a code segment and at least one corresponding code error; selecting a fine-tuned code large language model 268 based on the code segment; instantiating at least one dynamic pipeline 256, the at least one dynamic pipeline 256 comprising the selected fine-tuned code large language model 268 and a code adaptation action recommender 264; generating, using the instantiated at least one dynamic pipeline 256, adapted code based on the code segment and the at least one corresponding code error; and deploying the adapted code (operation 260). The technical benefits include a retrieval augmented generative (RAG) architecture used with pre-trained LLMs to automatically perform code generation and code adaptation using fine-tuned large language models; automated code generation for vendor-proprietary equipment; automation and support for intent-based networking; avoids dependencies on third-party vendors for code generation; a method for dynamic instantiation of dynamic pipelines for code segment adaptation; a method for recommendation of code adaptation actions; code adaptation via a code-specific LLM; and more efficient and shorter software development time.

In example embodiments, the deployed adapted code is tested (operation 260). The technical benefits include verification of the proper generation of the adapted code.

In example embodiments, the dynamic pipeline 256 is reconfigured in response to the deployed adapted code failing the testing; another version of the adapted code is generated using the reconfigured dynamic pipeline 256 (operation 268); the other version of the adapted code is deployed (operation 260); and the other version of the adapted code is tested (operation 260). The technical benefits include reconfiguring the dynamic pipeline 256 and generating another version of the adapted code in response to the deployed adapted code failing the testing.

In example embodiments, the reconfiguring of the dynamic pipeline 256 comprises at least one of utilizing different documentation 220-1, 220-2, . . . , 220-N and utilizing different embeddings 224-1, 224-2, . . . , 224-M of a knowledge base 228. The technical benefits include the exploration of alternative solutions for generating the adapted code.

In example embodiments, the adapted code is forwarded to a general large language model 248; and pipeline information is stored in a code adaptation knowledge base 276. The technical benefits include a code adaptation knowledge base for storing previously established dynamic pipelines and their operational data.

In example embodiments, a code adaptation knowledge base 276 is searched for historical pipeline information corresponding to the code error; and the historical pipeline information is retrieved in response to locating the historical pipeline information in the code adaptation knowledge base 276, wherein the instantiating of the at least one dynamic pipeline 256 is based on the retrieved historical pipeline information. The technical benefits include exploiting the knowledge gained in addressing earlier code errors when correcting a new code error.

In example embodiments, the historical pipeline information comprises a configuration of a historical pipeline 256, an identification of documentation 220-1, 220-2, . . . , 220-N used to resolve the code error, embeddings 224-1, 224-2, . . . , 224-M used to resolve the code error, a number of iterations required to solve the code error, and a type of code adaptation large language model 268. The technical benefits include an improved way of exploiting the knowledge gained in addressing earlier code errors when correcting a new code error.

In example embodiments, a code adaptation knowledge base 276 is searched for historical pipeline information corresponding to the code error; and a search for the fine-tuned code large language model 268 that is most closely applicable to the code error is performed in response to failing to locate the historical pipeline information in the code adaptation knowledge base 276, wherein the instantiating of the at least one dynamic pipeline 256 is based on the fine-tuned code large language model 268. The technical benefits include a retrieval augmented generative (RAG) architecture used with pre-trained LLMs to automatically perform code generation and code adaptation using fine-tuned large language models and a method for dynamic instantiation of dynamic pipelines for code segment adaptation when relevant historical pipeline information is not located in the code adaptation knowledge base 276.

In example embodiments, a human language intent 236 that describes a specific task to be executed is obtained; a prompt template 240 is generated based on the human language intent 236; relevant embeddings 224-1, 224-2, . . . , 224-M are retrieved from a knowledge base 228; the prompt template 240 is enhanced based on the relevant embeddings 224-1, 224-2, . . . , 224-M; the code segment is generated using a general large language model based on the enhanced prompt; and the code segment is tested using automation test scripts 232 (operation 252). The technical benefits include a retrieval augmented generative (RAG) architecture used with pre-trained LLMs to automatically perform code generation and code adaptation using fine-tuned large language models; and automated code generation for vendor-proprietary equipment.

In example embodiments, one or more embeddings 224-1, 224-2, . . . , 224-M are generated from documentation 220-1, 220-2, . . . , 220-N; and the embeddings 224-1, 224-2, . . . , 224-M are stored in the knowledge base 228. The technical benefits include an improved way of exploiting the knowledge gained in addressing earlier code errors when correcting a new code error.

In one aspect, a computer program product comprises one or more tangible computer-readable storage media and program instructions stored on at least one of the one or more tangible computer-readable storage media, the program instructions executable by a processor, the program instructions comprising obtaining a code segment and at least one corresponding code error; selecting a fine-tuned code large language model 268 based on the code segment; instantiating at least one dynamic pipeline 256, the at least one dynamic pipeline 256 comprising the selected fine-tuned code large language model 268 and a code adaptation action recommender 264; generating, using the instantiated at least one dynamic pipeline 256, adapted code based on the code segment and the at least one corresponding code error; and deploying the adapted code (operation 260). The technical benefits include a retrieval augmented generative (RAG) architecture used with pre-trained LLMs to automatically perform code generation and code adaptation using fine-tuned large language models; automated code generation for vendor-proprietary equipment; automation and support for intent-based networking; avoids dependencies on third-party vendors for code generation; a method for dynamic instantiation of dynamic pipelines for code segment adaptation; a method for recommendation of code adaptation actions; code adaptation via a code-specific LLM; and more efficient and shorter software development time.

In one aspect, an apparatus comprises a memory and at least one processor, coupled to the memory, and operative to perform operations comprising obtaining a code segment and at least one corresponding code error; selecting a fine-tuned code large language model 268 based on the code segment; instantiating at least one dynamic pipeline 256, the at least one dynamic pipeline 256 comprising the selected fine-tuned code large language model 268 and a code adaptation action recommender 264; generating, using the instantiated at least one dynamic pipeline 256, adapted code based on the code segment and the at least one corresponding code error; and deploying the adapted code (operation 260). The technical benefits include a retrieval augmented generative (RAG) architecture used with pre-trained LLMs to automatically perform code generation and code adaptation using fine-tuned large language models; automated code generation for vendor-proprietary equipment; automation and support for intent-based networking; avoids dependencies on third-party vendors for code generation; a method for dynamic instantiation of dynamic pipelines for code segment adaptation; a method for recommendation of code adaptation actions; code adaptation via a code-specific LLM; and more efficient and shorter software development time.

Techniques as disclosed herein can provide substantial beneficial technical effects. Some embodiments may not have these potential advantages and these potential advantages are not necessarily required of all embodiments. By way of example only and without limitation, one or more embodiments can provide one or more of:
a retrieval augmented generative (RAG) architecture used with pre-trained LLMs to automatically perform code generation and code adaptation using fine-tuned large language models;
automated code generation for vendor-proprietary equipment;
automation and support for intent-based networking;
avoids dependencies on third-party vendors for code generation;
a method for dynamic instantiation of dynamic pipelines for code segment adaptation;
a method for recommendation of code adaptation actions;
code adaptation via a code-specific LLM; and
a code adaptation knowledge base for storing previously established dynamic pipelines and their operational data.

Furthermore, aspects of the invention provide numerous other technical benefits. In one non-limiting specific example, telephone company (telco) operations and other industries are becoming more and more automated. Solutions for automated end-to-end operation must interact with network management systems (NMSs) and element management systems (EMSs) of various vendors. For this to occur, the operator's engineering teams typically must write scripts using vendor-proprietary application programming interfaces (APIs) covering each different edge condition. Targeted automation scripts tailored for different edge hardware/conditions in telco networks offer many pertinent benefits, including:
optimized performance: scripts are optimized for specific hardware, traffic patterns, and environmental factors, ensuring efficient network operation;
reliability: consistent performance across diverse conditions minimizes downtime and disruptions;
resource efficiency: dynamic resource allocation maximizes network capacity and minimizes latency;
compliance and security: scripts enforce regulatory compliance and enhance security measures tailored to each edge environment;
cost savings: reduced operational costs through streamlined management and optimized resource usage;
scalability and flexibility: facilitates rapid deployment and scaling of services as network demands grow; and
enhanced customer experience: ensures consistent service delivery and the meeting of customer expectations for reliability and performance.

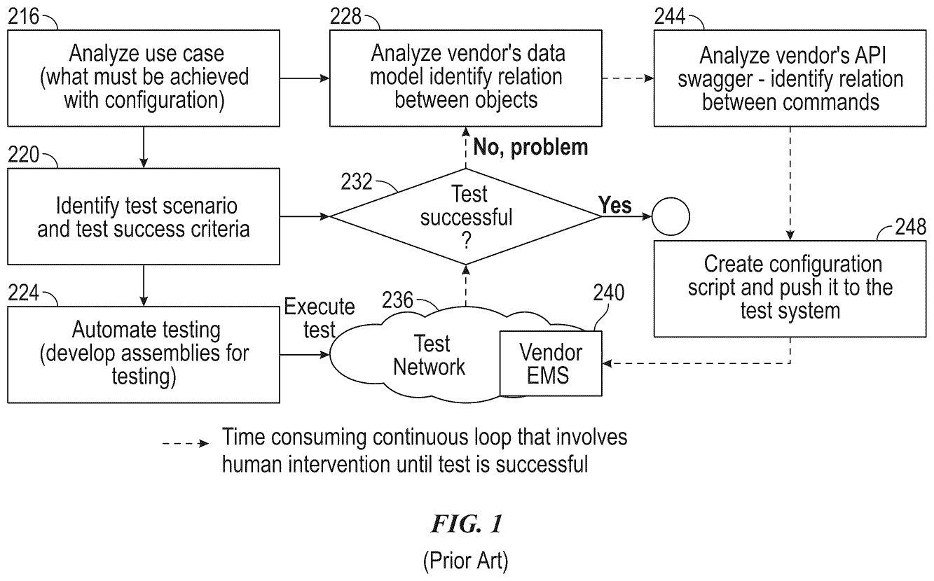

FIG. 1 is an example conventional workflow for generating vendor-specific software. In example embodiments, operations 216-224 are performed once for each specified software component and operations 228-248 are performed over one or more iterations. Initially, use cases for the software component are analyzed (operation 216), a test scenario(s) and test success criteria are identified (operation 220) and automated testing is instantiated (operation 224).

In example embodiments, a vendor's data model is analyzed and the relations between objects are identified (operation 228), the vendor's API documentation is analyzed and the relations between commands are identified (operation 244) and a configuration script is created and pushed to the test system (operation 248). The tests defined during operations 216-224 are then tested on the test network using vendor EMS 240 (operation 236). A check is performed to determine if the test(s) were successful (operation 232). If the test(s) were successful (YES branch of decision block 232), the workflow ends; otherwise (NO branch of decision block 232), the workflow proceeds with operation 228.

### Method for Recommendation of Code Adaptation Action

Generally, techniques are provided for automatically generating code. In example embodiments, a retrieval augmented generative (RAG) architecture is used with pre-trained LLMs to automatically perform code generation and code adaptation; documentation that is relevant for automated code generation is ingested, fragmented into paragraphs, and stored as embeddings; and a conventional pipeline is used to generate the initial code, such as edge code.

In example embodiments, a dynamic pipeline is introduced for individual code modifications that modifies the generated code over one or more iterations, with RAG retrievals, until successful (each iteration potentially configured with a different setup). An exemplary method for dynamic instantiation of a dynamic pipeline for code segment adaptation leverages a code adaptation knowledge base to identify the best code adaptation pipeline configuration (e.g., a RAG configuration with a code-specific LLM (CodeLLM)). During the pipeline instantiation, the method for dynamic instantiation learns which documents in a RAG database are utilized for each new iteration (e.g., randomized retrievals, retrievals with a specific order for the documents in the RAG database, retrievals based on similar historical dynamic pipelines and the like). The method for dynamic instantiation takes the output of the RAG database and the error code from the validation test, and generates a modified version of the code (via the CodeLLM) which removes the error from the initially generated code. The process is repeated until a validation test(s) succeeds. For example, the data acquired during the “production phase” can be monitored to enable the performance of an infinite loop for dynamic continuous improvement of the steps above.

In each new iteration, the CodeLLM receives the code adaptation action from the method for dynamic instantiation and retrieves enrichment information from the RAG database as per the pipeline configuration; the CodeLLM adapts the code accordingly. The process repeats until the validation test succeeds (where, in a non-limiting example, a response code of 200 OK is received upon a successful test of website software). In the case where the code adaptation does not receive a 200 OK response code after a specified number of iterations, the algorithm stops and indicates that the documentation from the RAG database used in the pipeline is not sufficient to correct the detected errors. During processing, a code adaptation knowledge base tracks all the code adaptation attempts from each iteration within each code adaptation pipeline and stores them to make them available for use when the same or a similar error is encountered in the future.

In example embodiments, the testing output from the EMS is leveraged to identify the code errors when the code is deployed on it. In the case of a code execution failure, the EMS typically provides a description of the error. For example, a conventional cloud-delivered, software-defined wide area network issues the following commands:

### Invalid Json Format

{“error”: “ValidationError”, “message”: “Invalid JSON format. Ensure the request payload is a well-formed JSON object.”}

### Missing Required Field

{“error”: “ValidationError”, “message”: “The ‘name’ field is required but was not provided in the request.”}

### Invalid Data Type

{“error”: “ValidationError”, “message”: “Invalid data type for ‘bandwidth’: Expected a numeric value.”}

### Invalid Enum Value

{“error”: “ValidationError”, “message”: “Invalid value for ‘protocol’: Must be either ‘TCP’ or ‘UDP’.”}

### Length Constraint Violation

{“error”: “ValidationError”, “message”: “The length of ‘description’ exceeds the maximum allowed characters.”}

### Dependency Error

{“error”: “ValidationError”, “message”: “The ‘destinationPort’ field is required when ‘protocol’ is set to ‘UDP’.”}

### Automated Code Generation System

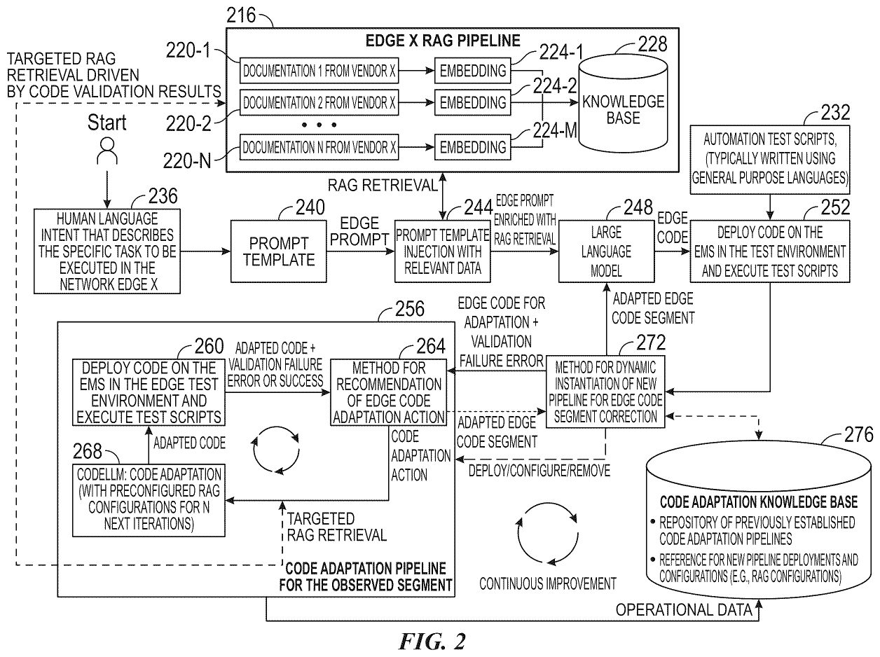

FIG. 2 is a block diagram of an example system for automated code generation using pretrained LLMs enhanced by dynamically established pipelines, in accordance with example embodiments. In example embodiments, a human language intent 236 that describes a specific task to be executed is obtained. For example, a specific task to be executed in network edge x may be obtained from a user. A prompt template 240 is generated based on the human language intent 236. Given the teachings herein, the generation of the prompt template 240 can be performed by the skilled artisan by adapting known techniques, such as natural language processing.

A retrieval augmented generator 216 generates embeddings 224-1, 224-2, . . . , 224-M from documentation 220-1, 220-2, . . . , 220-N and stores the embeddings 224-1, 224-2, . . . , 224-M in a knowledge base 228. In example embodiments, the prompt template 240 is submitted to the retrieval augmented generator 216 and the embeddings 224-1, 224-2, . . . , 224-M relevant to the submitted prompt template 240 are retrieved from the knowledge base 228 and used to enhance the prompt template 240 via a prompt template injector 244. The resulting prompt, such as an edge prompt, enriched with the RAG retrieval embeddings 224-1, 224-2, . . . , 224-M, is submitted to a large language model (LLM) 248. The LLM 248 generates code, such as edge code, based on the enriched prompt. As per operation 252, the generated code is deployed on, for example, an EMS in a test environment and the code is tested using automation test scripts 232.

In example embodiments, if errors are encountered during testing, the generated code and discovered errors are submitted to a method for dynamic instantiation 272 which, for example, instantiates a dynamic pipeline 256 for code segment correction, such as edge code segment correction, based on a code adaptation LLM 268. The selected code adaptation LLM 268 is fine-tuned, for example, for specific APIs, automation code, NMS code, EMS code and the like. If multiple errors are encountered, dynamic pipelines can be instantiated, either serially or in parallel, to process the errors. In the case of parallel processing, the code corrections discovered can be simultaneously applied to the newly generated code. In general, dynamic pipelines 256 can be deployed, configured, reconfigured (including selecting a new code adaptation LLM 268) and removed.

The method for dynamic instantiation 272 checks with a code adaptation knowledge base 276 to determine if the discovered error has been encountered before. For example, the type of error (such as an invalid data type), the software product, and the like, can be submitted to the code adaptation knowledge base 276 and a search for a corresponding historical pipeline instantiation can be conducted. If the error (or a similar error) has been encountered before, the code adaptation knowledge base 276 is accessed to retrieve information describing the pipeline that was used to solve the historical problem. For example, the configuration of the dynamic pipeline 256, an identification of the RAG documentation 220-1, 220-2,. . . , 220-N used to resolve the problem, the new and/or closest embeddings 224-1, 224-2,. . . , 224-M used to resolve the problem, the number of iterations required to solve the problem, the type of code adaptation LLM 268 used to solve the problem and the like are retrieved from the knowledge base 276. A dynamic pipeline 256 is instantiated based on the retrieved information.

If a pipeline instantiation applicable to the detected error is not found in the knowledge base 276, the method for dynamic instantiation 272 searches for a code adaptation LLM 268 that is most closely applicable to the error at hand (based, for example, on the corresponding software product that was tested) and instantiates a dynamic pipeline 256 based on the discovered code adaptation LLM 268.

In either case, a method of recommendation of code adaptation action 264 is instantiated as part of the dynamic pipeline 256. The method of recommendation of code adaptation action 264 coordinates the generation of adapted code by the code adaptation LLM 268, including determining actions to be performed by the dynamic pipeline 256. The method of recommendation 264 identifies specific documents in the RAG knowledge base 228 which match given keyword(s) or basic preset criteria for the error and/or software product, and/or which were identified by the code adaptation knowledge base 276. The method of recommendation 264 coordinates the submission of the code, the error type, and the embeddings 224-1, 224-2, . . . , 224-M generated from the selected documentation 220-1, 220-2, . . . , 220-N to the code adaptation LLM 268. In example embodiments, the method for recommendation 264 is implemented using an LLM that interprets the ValidationError and provides a recommendation on the code adaptation action (e.g., set the ‘destinationPort’ field) to be used as the input for the code adaptation LLM 268.

Once generated, the generated adapted code is deployed on, for example, the EMS in the test environment and the adapted code is tested using, for example, the automation test scripts 232 (operation 260). The adapted code, with an indication of the validation failure or success of the test(s), is provided to the method of recommendation of edge code adaptation action 264. If the adapted code does not pass the assigned test(s), a new configuration of the pipeline 256 is established (such as utilizing different documentation 220-1, 220-2, . . . , 220-N/embeddings 224-1, 224-2 224-M of the RAG knowledge base 228). The code adaptation LLM 268 then generates another version of the adapted code and the testing process is repeated.

If the adapted code passes the test, the adapted edge code segment is returned to the method for dynamic instantiation 272, which forwards the adapted edge code segment to the large language model 248. In addition, the information describing the dynamic pipeline 256 that was used to solve the problem is added to the code adaptation knowledge base 276. For example, the configuration of the pipeline 256, an identification of the RAG documentation 220-1, 220-2,. . . , 220-N used to solve the problem, the new and/or closest embeddings 224-1, 224-2,. . . , 224-M used to solve the problem, the number of iterations taken to solve the problem, the type of code LLM 268 used in the dynamic pipeline 256 and the like are stored in the knowledge base 276 for each iteration.

### Rag Documents

Each document in the RAG knowledge base 228 provides specific knowledge regarding a corresponding system(s). Non-limiting example of documents in the RAG knowledge base 228 include vendor documents (such as portable document format documents (PDFs), scripts and other documents), programmer's guides (including guides describing an initial authentication function), structured data (such as end-to-end virtual private routed network (VPRN) service configurations), unstructured data (such as help documentation for virtual private network (VPN) services), screenshots (such as a screenshot of example error messages for a given JSON message) and the like.

### CodeLLM: Code Adaptation

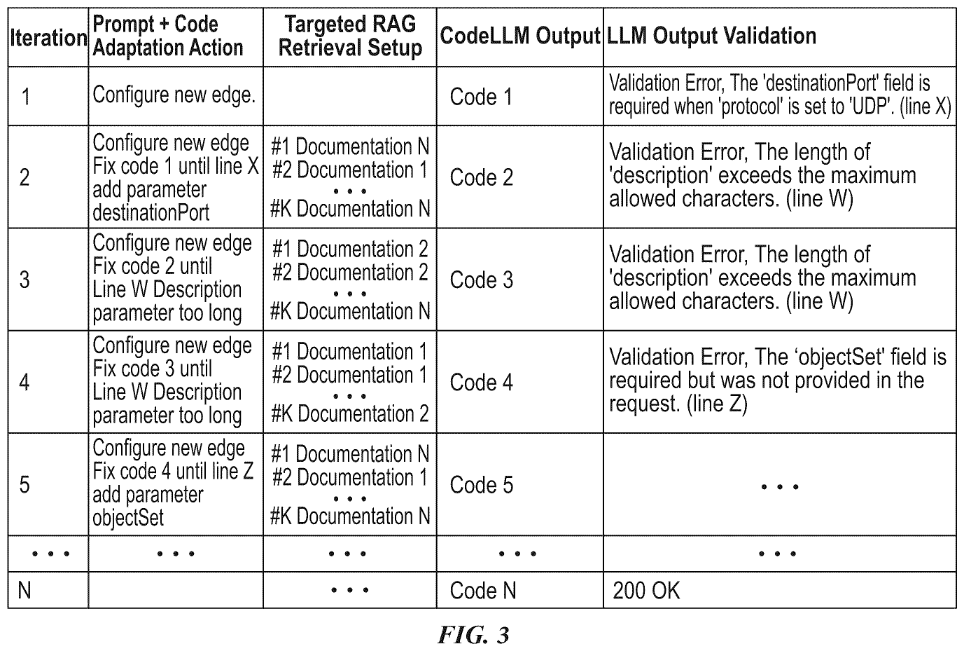

FIG. 3 is a table of example information generated during multiple iterations of code adaptation, in accordance with example embodiments. For example, each row of the table of FIG. 3 represents one iteration of the code adaptation. As illustrated in row 2 of FIG. 3, the first column identifies the iteration number, the second column identifies the prompt plus the code adaptation action, the third column identifies the RAG documents 220-1, 220-2, . . . , 220-N used during the iteration, the fourth column identifies the output of the code adaptation LLM 268 and the fifth column identifies the outcome validation of the output of the code adaptation LLM 268.

### Code Adaptation Knowledge Base

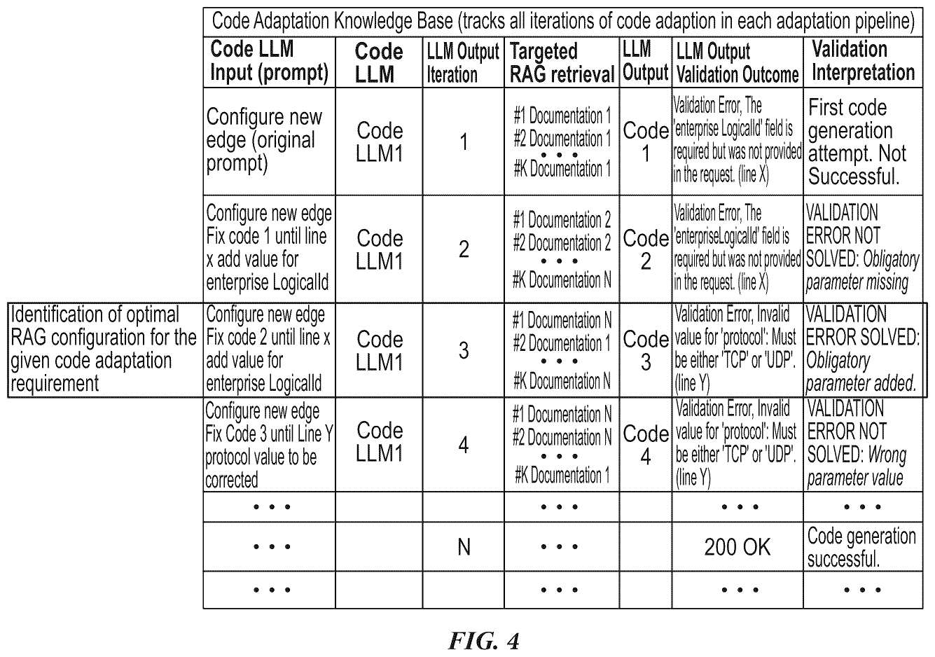

FIG. 4 is a table of example information maintained by the code adaptation knowledge base 276, in accordance with example embodiments. In example embodiments, the code adaptation knowledge base 276 tracks iterations of code adaptation in each adaptation pipeline 256. For example, each row of the table of FIG. 4 may represent one iteration of the code adaptation. As illustrated in row 3 of FIG. 4, the first column identifies the code adaptation LLM input (prompt), the second column identifies the specific code adaptation LLM 268 used during the iteration, the third column identifies the iteration number of the corresponding row, the fourth column identifies the documentation 220-1, 220-2, . . . , 220-N in the knowledge base 228 used during the iteration, the fifth column identifies the output of the code adaptation LLM 268, the sixth column identifies the outcome validation of the output of the code adaptation LLM 268 and the seventh column identifies the validation interpretation.

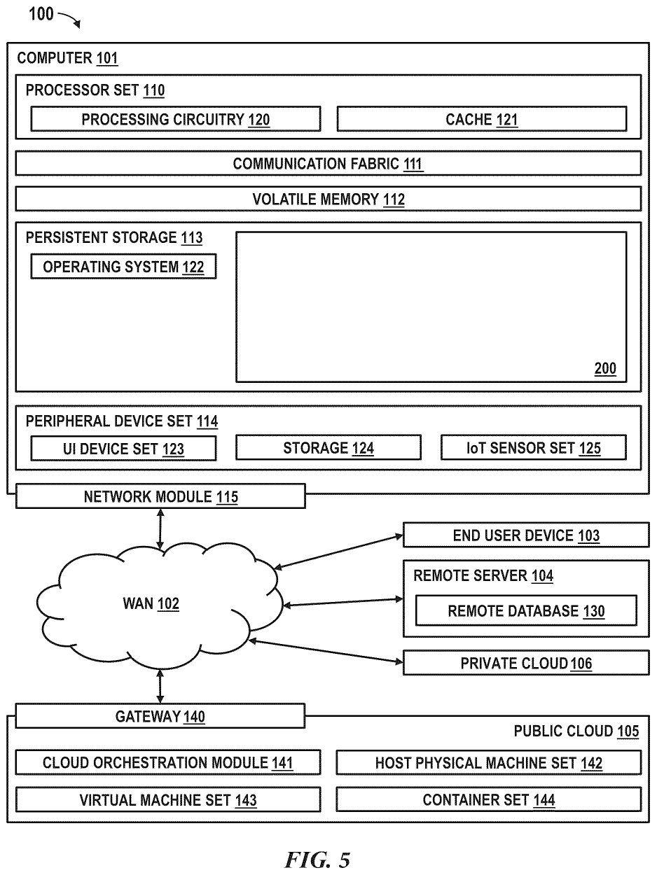

Refer now to FIG. 5.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as computer-aided software development system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining a code segment and at least one corresponding code error;
selecting a fine-tuned code large language model based on the code segment;
instantiating at least one dynamic pipeline, the at least one dynamic pipeline comprising the selected fine-tuned code large language model and a code adaptation action recommender;
generating, using the instantiated at least one dynamic pipeline, adapted code based on the code segment and the at least one corresponding code error; and
deploying the adapted code.

2. The method of claim 1, further comprising testing the deployed adapted code.

3. The method of claim 2, further comprising:
reconfiguring the dynamic pipeline in response to the deployed adapted code failing the testing;
generating, using the reconfigured dynamic pipeline, another version of the adapted code;
deploying the other version of the adapted code; and
testing the other version of the adapted code.

4. The method of claim 3, wherein the reconfiguring of the dynamic pipeline comprises at least one of utilizing different documentation and utilizing different embeddings of a knowledge base.

5. The method of claim 2, further comprising:
forwarding the adapted code to a general large language model; and
storing pipeline information in a code adaptation knowledge base.

6. The method of claim 5, further comprising:
searching a code adaptation knowledge base for historical pipeline information corresponding to the code error; and
retrieving the historical pipeline information in response to locating the historical pipeline information in the code adaptation knowledge base, wherein the instantiating of the at least one dynamic pipeline is based on the retrieved historical pipeline information.

7. The method of claim 6, wherein the historical pipeline information comprises a configuration of a historical pipeline, an identification of documentation used to resolve the code error, embeddings used to resolve the code error, a number of iterations required to solve the code error, and a type of code adaptation large language model.

8. The method of claim 1, further comprising:
searching a code adaptation knowledge base for historical pipeline information corresponding to the code error; and
searching for the fine-tuned code large language model that is most closely applicable to the code error in response to failing to locate the historical pipeline information in the code adaptation knowledge base, wherein the instantiating of the at least one dynamic pipeline is based on the fine-tuned code large language model.

9. The method of claim 1, further comprising:
obtaining a human language intent that describes a specific task to be executed;
generating a prompt template based on the human language intent;
retrieving relevant embeddings from a knowledge base;
enhancing the prompt template based on the relevant embeddings;
generating, using a general large language model, the code segment based on the enhanced prompt; and
testing the code segment using automation test scripts.

10. The method of claim 9, further comprising:
generating one or more embeddings from documentation; and
storing the embeddings in the knowledge base.

11. A computer program product, comprising:
one or more tangible computer-readable storage media and program instructions stored on at least one of the one or more tangible computer-readable storage media, the program instructions executable by a processor, the program instructions comprising:
obtaining a code segment and at least one corresponding code error;
selecting a fine-tuned code large language model based on the code segment;
instantiating at least one dynamic pipeline, the at least one dynamic pipeline comprising the selected fine-tuned code large language model and a code adaptation action recommender;
generating, using the instantiated at least one dynamic pipeline, adapted code based on the code segment and the at least one corresponding code error; and
deploying the adapted code.

12. A system comprising:
a memory; and
at least one processor, coupled to said memory, and operative to perform operations comprising:
obtaining a code segment and at least one corresponding code error;
selecting a fine-tuned code large language model based on the code segment;
instantiating at least one dynamic pipeline, the at least one dynamic pipeline comprising the selected fine-tuned code large language model and a code adaptation action recommender;
generating, using the instantiated at least one dynamic pipeline, adapted code based on the code segment and the at least one corresponding code error; and
deploying the adapted code.

13. The system of claim 12, the operations further comprising testing the deployed adapted code.

14. The system of claim 13, the operations further comprising:
reconfiguring the dynamic pipeline in response to the deployed adapted code failing the testing;
generating, using the reconfigured dynamic pipeline, another version of the adapted code;
deploying the other version of the adapted code; and
testing the other version of the adapted code.

15. The system of claim 14, wherein the reconfiguring of the dynamic pipeline comprises at least one of utilizing different documentation and utilizing different embeddings of a knowledge base.

16. The system of claim 13, the operations further comprising:
forwarding the adapted code to a general large language model; and
storing pipeline information in a code adaptation knowledge base.

17. The system of claim 16, the operations further comprising:
searching a code adaptation knowledge base for historical pipeline information corresponding to the code error; and
retrieving the historical pipeline information in response to locating the historical pipeline information in the code adaptation knowledge base, wherein the instantiating of the at least one dynamic pipeline is based on the retrieved historical pipeline information.

18. The system of claim 12, the operations further comprising:
searching a code adaptation knowledge base for historical pipeline information corresponding to the code error; and
searching for the fine-tuned code large language model that is most closely applicable to the code error in response to failing to locate the historical pipeline information in the code adaptation knowledge base, wherein the instantiating of the at least one dynamic pipeline is based on the fine-tuned code large language model.

19. The system of claim 12, the operations further comprising:
obtaining a human language intent that describes a specific task to be executed;
generating a prompt template based on the human language intent;
retrieving relevant embeddings from a knowledge base;
enhancing the prompt template based on the relevant embeddings;
generating, using a general large language model, the code segment based on the enhanced prompt; and
testing the code segment using automation test scripts.

20. The system of claim 19, the operations further comprising:
generating one or more embeddings from documentation; and
storing the embeddings in the knowledge base.
